(19) United States
(12) Patent Application Publication
(10) Pub. No.: US 2006/0139785 A1
(43) Pub. Date: Jun. 29, 2006

(54) Magnetic transfer method and apparatus

(75) Inventor: Akito Kamatani, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/299,941

(22) Filed: Dec. 13, 2005

(30) Foreign Application Priority Data
Dec. 28, 2004 (JP) 2004-380075

(51) Int. Cl. G11B 5/86

(52) U.S. Cl. 360/17

(57) ABSTRACT

According to the present invention, since the suction force of the suction holes or suction grooves formed in the suction surface is varied among the joining step, transfer step, and separation step according to the suction force needed to hold the master disk in the respective steps, the suction force is not uniformly maintained at a high level as in a conventional manner. This minimizes deformation of the master disk in portions which correspond to the suction holes or suction grooves in the suction surface, and thereby prevents degradation of signal output or displacement of recording position during magnetic transfer. Moreover, since the suction force of the suction holes or suction grooves formed in the suction surface is varied according to the suction force needed to hold the master disk in the individual steps, it is possible to securely hold the master disk by suction, preventing it from falling off the suction surface.

### BACKGROUND OF THE INVENTION

1. Field of the Invention

The present invention relates to a magnetic transfer method and apparatus. More particularly, it relates to an improvement to a suction holding technique for suction-holding the back side of a master disk to a suction surface of a holder, where concavo-convex patterns representing an information signal are formed on the front side of the master disk.

2. Description of the Related Art

Generally, with increases in the amount of information, there is demand for magnetic recording media which have a large capacity to record large amounts of information, cost less, and preferably, lend themselves to high-speed access to allow a required area to be accessed quickly. As examples of such magnetic recording media, high-density flexible disks and high-density hard disks are known. In achieving a high capacity, an important role is played by so-called tracking servo technology according to which a magnetic head accurately scans narrow tracks to reproduce signals at a high S/N ratio. During one rotation of a disk, a tracking servo signal, address information signal, reproduction clock signal, and the like are written as so-called preformatted information at certain intervals. The magnetic head can move on tracks accurately by reading the preformatted information and thereby correcting its own position.

Although the writing can be done by the magnetic head, it takes time. Thus, it is efficient to transfer all the preformatted information at once from a master disk containing it, and a magnetic transfer apparatus (e.g., Japanese Patent Application Laid-Open No. 10-269566) has been proposed.

The magnetic transfer apparatus holds, to a holder, a master disk containing concavo-convex patterns representing information to be transferred to a target disk (slave disk) and magnetically transfers preformatted information (e.g., a servo signal) represented by the concavo-convex patterns to the slave disk by applying a magnetic field for transfer with the master disk and slave disk held in pressing contact. In magnetic transfer, to ensure sufficiently close contact, it is important that the master disk is basically flat, but sometimes the master disk is not flat enough depending on the production method of the master disk. Such a master disk poses a problem of reduced transfer accuracy because of insufficient contact between the master disk and slave disk.

To deal with this problem, the applicant has proposed in Japanese Patent Application Laid-Open No. 2002-163823 to hold the back side of a master disk where no concavo-convex pattern is formed to a sufficiently flat suction surface by suction either directly or via cushioning which has suction holes for sufficient suction force. Consequently, even if the master disk is not flat enough, it can be brought into close contact with the slave disk, with improved flatness, by following the sufficiently flat suction surface.

### SUMMARY OF THE INVENTION

However, although the technique disclosed in Japanese Patent Application Laid-Open No. 2002-163823 ensures macroscopic flatness of the master disk, when the master disk sucked to the suction surface is viewed microscopically, the master disk deforms slightly in portions which correspond to the suction holes in the suction surface.

Consequently, gaps between the slave disk and deformed portions of the master disk, inward displacement of the master disk, and the like can cause degradation of signal output or displacement of recording position during magnetic transfer.

To deal with this situation, it is conceivable to reduce the size of the suction holes or use porous material for the holder, but these measures will make the master disk prone to fall off the holder. Besides, even if the suction surface has high flatness, these measures cannot raise the flatness of the master disk to a required level if the suction force is not sufficient. Furthermore, they do not provide substantial measures because they cannot meet size restrictions, involve high equipment costs, and so on.

The present invention has been made in view of the above circumstances and has an object to provide a master-disk suction-holding method and magnetic transfer apparatus which can securely hold a master disk to a suction surface of a holder and do not cause degradation of signal output or displacement of recording position during magnetic transfer.

As described above, when viewed microscopically, the master disk sucked to the suction surface of the holder deforms slightly in portions which correspond to the suction holes in the suction surface. The deformation increases with increases in the suction force of the suction holes or suction grooves as well as with increases in the duration during which high suction force is maintained, but too small a suction force causes the master disk to fall off the suction surface.

However, the suction force required to hold the master disk to the suction surface by suction varies among a joining step, transfer step, and separation step, which are main steps of magnetic transfer, and it is not necessary to uniformly maintain the suction force as in a conventional manner at the level of the separation step which requires the highest suction force. The present invention has been made based on this idea.

To achieve the above object, a first aspect of the present invention provides a magnetic transfer method, comprising: a joining step of overlaying a master disk held by suction to a suction surface of a holder on a target disk and bringing the master disk and the target disk into pressing contact with each other; a transfer step of magnetically transferring concavo-convex patterns which represent information on the master disk to the target disk by applying a magnetic field with the master disk and the target disk held in pressing contact; and a separation step of separating the target disk from the master disk after transfer, wherein suction force of suction holes or suction grooves formed in the suction surface is varied according to suction force needed to hold the master disk in the individual steps.

Incidentally, the suction holes according to the present invention include pores in a suction surface made of porous material.

According to the first aspect of the present invention, since the suction force of the suction holes or suction grooves formed in the suction surface is varied among the joining step, transfer step, and separation step according to the suction force needed to hold the master disk in the respective steps, the suction force is not uniformly maintained at a high level as in a conventional manner. This minimizes deformation of the master disk in portions which correspond to the suction holes or suction grooves in the suction surface, and thereby prevents degradation of signal output or displacement of recording position during magnetic transfer. Moreover, since the suction force of the suction holes or suction grooves formed in the suction surface is varied according to the suction force needed to hold the master disk in the individual steps, the present invention makes it possible to securely hold the master disk by suction, preventing it from falling off the suction surface.

A second aspect of the present invention provides the magnetic transfer method according to the first aspect, wherein the suction force of the suction holes or suction grooves is set lower during a transfer operation in the transfer step than in the separation step.

That is, since the master disk undergoing transfer in the transfer step has been placed in pressing contact with the target disk in the joining step preceding the transfer step, it does not fall off the suction surface even if the suction force of the suction holes or suction grooves is reduced. In this way, by reducing the suction force of the suction holes or suction grooves in the transfer step, it is possible to minimize deformation of the master disk in portions which correspond to the suction holes or suction grooves.

On the other hand, if the suction force of the suction holes or suction grooves is reduced in the separation step, the master disk will fall off the suction surface because separation force is applied to separate the target disk from the master disk. Thus, it is necessary to set the suction force of the suction holes or suction grooves in the separation step higher than in the transfer step. However, when all the steps are considered as a whole, since the suction force of the suction holes or suction grooves is set low in the transfer step, it is possible to reduce the duration during which the suction force is set high and thereby reduce deformation of the master disk.

A third aspect of the present invention provides the magnetic transfer method according to the first or second aspect, wherein the suction force of the suction holes or suction grooves in the joining step is set to be intermediate between the suction force in the transfer step and the suction force in the separation step.

When the master disk is placed in pressing contact with the target disk in the joining step, if the suction force of the suction holes or suction grooves is too low, the center of the master disk and the center of the target disk will be misaligned with each other. However, the joining step does not require so high a suction force as the separation step, and preferably the suction force in the joining step is intermediate between the suction forces in the transfer step and separation step. This makes it possible to reduce the time in which the suction force is set high and thereby reduce deformation of the master disk.

A fourth aspect of the present invention provides the magnetic transfer method according to any of the first to third aspects, wherein the suction force of the suction holes or suction grooves during a transfer operation in the transfer step ranges from 0 to −60 kPa in terms of vacuum created by a vacuum system which generates the suction force of the suction holes or suction grooves.

The fourth aspect specifies a preferable range of the suction force of the suction holes or suction grooves during the transfer operation in the transfer step and the preferable range is from 0 to −60 kPa in terms of the vacuum created by the vacuum system which generates the suction force of the suction holes or suction grooves. The minimum degree of vacuum of 0 kPa corresponds to the atmospheric pressure at which the suction force of the suction holes or suction grooves is zero. Since the master disk is placed in pressing contact with the target disk during transfer as described above, it does not fall off the suction surface even at a pressure of 0 kPa. A more preferable range of the suction force of the suction holes or suction grooves during transfer is from 0 to −20 kPa.

A fifth aspect of the present invention provides the magnetic transfer method according to any of the first to fourth aspects, further comprising: a supply step of supplying the target disk to the holder, the supply step being provided upstream of the joining step, wherein the suction force of the suction holes or suction grooves is kept as low as the suction force in the transfer step or the joining step until the target disk is supplied to the holder in the supply step.

Since the master disk in the holder is simply held to the holder until the target disk is supplied to the holder in the supply step, no such external force is exerted that will cause the master disk to fall off. Thus, there is no need to increase the suction force of the suction holes or suction grooves, and preferably the suction force in the supply step is kept as low as the suction force in the transfer step or the separation step. Consequently, even if the increased suction force of the suction holes or suction grooves causes the master disk to deform in the portions which correspond to the suction holes in the suction surface when the target disk is separated from the master disk, the deformation will not persist until the next transfer because the suction force in the supply step is kept at a low level until the next target disk is supplied to the holder and undergoes transfer. This prevents degradation of signal output or displacement of recording position during transfer.

A sixth aspect of the present invention provides the magnetic transfer method according to any of the first to fifth aspects, further comprising: a decompression step of decompressing a space formed by sealing the holder, the decompression step being provided between the joining step and the transfer step, wherein the suction force of the suction holes or suction grooves is lowered to a level of the suction force in the transfer step before a shift from the decompression step to the transfer step.

As the space formed by sealing the holder is decompressed, air entrapped between the master disk and target disk held in pressing contact is discharged, the master disk and target disk come into tight contact with each other. This reduces deformation of the master disk.

To achieve the above object, a seventh aspect of the present invention provides a magnetic transfer apparatus equipped with a holder which holds the back side of a master disk by suction to a suction surface which has suction holes or suction grooves, where concavo-convex patterns representing information are formed on the front side of the master disk, the magnetic transfer apparatus comprising: a suction force control mechanism which controls suction force of the suction holes or suction grooves.

According to the seventh aspect of the present invention, since the magnetic transfer apparatus comprises the suction force control mechanism which controls the suction force of the suction holes or suction grooves formed in the suction surface of the holder which holds the master disk by suction, the suction force of the suction holes or suction grooves can be varied according to the suction force needed by the individual devices of the magnetic transfer apparatus in the respective processes. This minimizes deformation of the master disk in portions which correspond to the suction holes or suction grooves. Also, since the suction force of the suction holes or suction grooves is varied according to the suction force needed by the individual devices, the master disk will not fall off the suction surface.

An eighth aspect of the present invention provides the magnetic transfer apparatus according to the seventh aspect, further comprising: a joining device which overlays a master disk held by suction to a suction surface of a holder on a target disk and brings the master disk and the target disk into,pressing contact with each other; a transfer device which magnetically transfers the concavo-convex patterns on the master disk to the target disk by applying a magnetic field with the master disk and the target disk held in pressing contact; and a separation device which separates the target disk from the master disk after transfer, wherein the suction force control mechanism controls the suction force of the suction holes or suction grooves according to suction force needed by the individual devices to hold the master disk.

According to the eighth aspect, since the suction force control mechanism controls the suction force of the suction holes or suction grooves according to the suction force needed by the joining device, transfer device, and separation device, it is possible to minimize deformation of the master disk in portions which correspond to the suction holes or suction grooves, and thereby prevent degradation of signal output and displacement of recording position during transfer. Moreover, since the suction force of the suction holes or suction grooves formed in the suction surface is varied according to the suction force needed by the individual devices to hold the master disk, the present invention makes it possible to securely hold the master disk by suction, preventing it from falling off the suction surface.

A ninth aspect of the present invention provides the magnetic transfer apparatus according to the seventh or eighth aspect, further comprising: a supply device which supplies the target disk to the holder, the supply device being provided upstream of the joining device; and a decompression device which decompresses a space formed by sealing the holder, the decompression device being provided between the joining device and the transfer device, wherein the suction force control mechanism controls the suction force of the suction holes or suction grooves according to suction force needed by the supply device and the decompression device to hold the master disk.

According to the ninth aspect, since the suction force control mechanism controls the suction force of the suction holes or suction grooves according to the suction force needed by the supply device and the decompression device to hold the master disk, it is possible to further reduce deformation of the master disk in portions which correspond to the suction holes or suction grooves.

A tenth aspect of the present invention provides a manufacturing method of magnetic recording media, employing the magnetic transfer method according to any of the first to sixth aspects. An eleventh aspect provides a magnetic recording medium manufactured by the manufacturing method according to the tenth aspect.

As described above, the magnetic transfer method and apparatus according to the present invention can hold the master disk securely to the suction surface of the holder, thereby preventing degradation of signal output and displacement of recording position during transfer.

### BRIEF DESCRIPTION OF THE DRAWINGS

FIG. 1 is a conceptual diagram illustrating an overall configuration of a magnetic transfer apparatus;

FIG. 2 is a perspective view showing how transfer is performed by the magnetic transfer apparatus;

FIG. 3 is an exploded block diagram of a joining unit;

FIG. 4 is an explanatory diagram illustrating concavo-convex patterns formed in master disks;

FIG. 5 is a sectional view illustrating a suction force control mechanism;

FIG. 6 is a sectional view showing a case in which cushioning is installed on suction surfaces;

FIGS. 7A to 7C are explanatory diagrams illustrating basic processes of a magnetic transfer method; and

FIG. 8 is a table according to an embodiment of the present invention.

### DETAILED DESCRIPTION OF THE PREFERRED EMBODIMENTS

A preferred embodiment of a magnetic transfer method and apparatus according to the present invention will be described below with reference to the accompanying drawings.

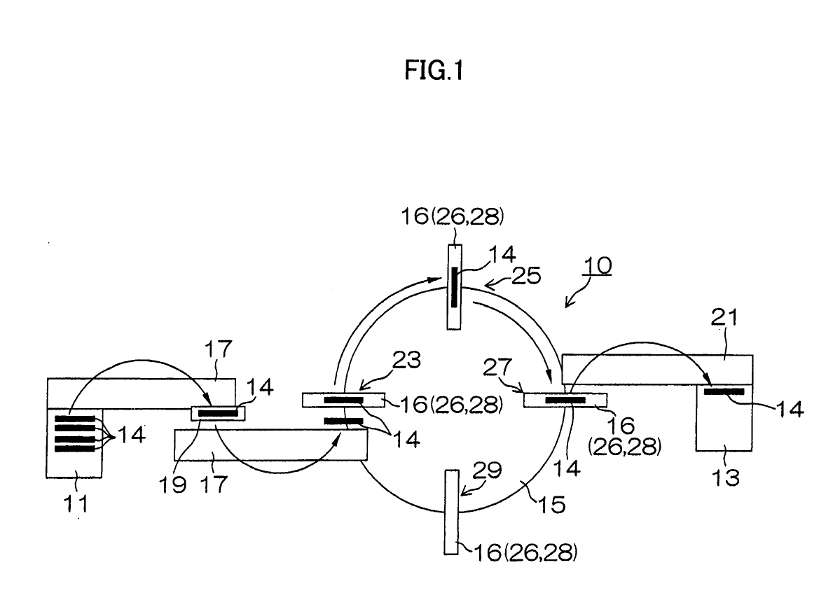

FIG. 1 is a conceptual diagram illustrating an overall configuration of a magnetic transfer apparatus 10. Incidentally, either of suction holes and suction grooves can be formed in a suction surface of a holder which holds a master disk, but an example in which suction holes are used will be described in this embodiment.

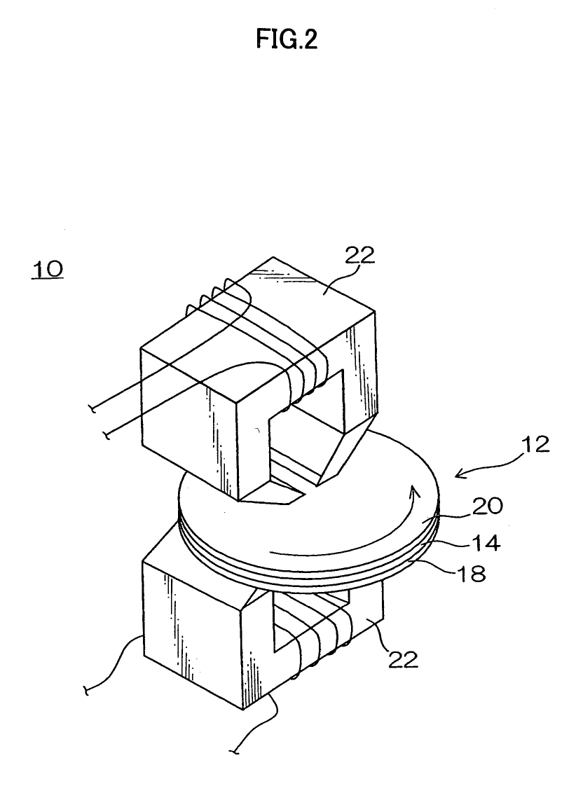

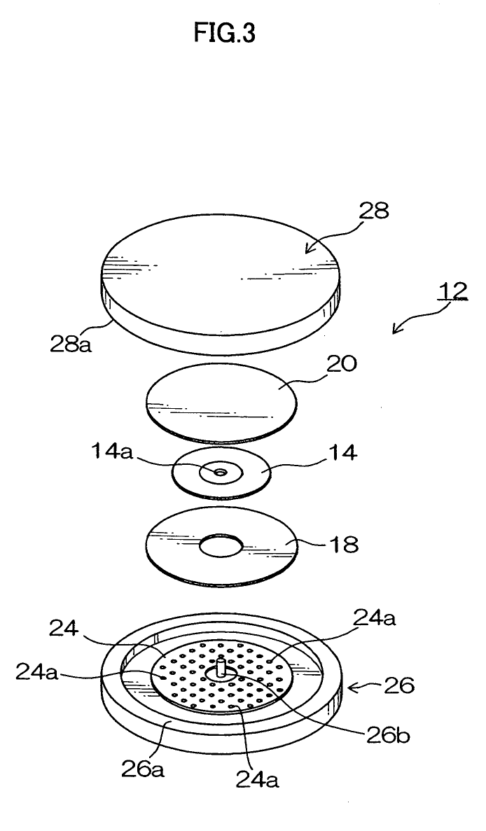

As shown in FIG. 1, at the upstream end of processes performed on the magnetic transfer apparatus 10, a supply cassette 11 is provided to house slave disks 14 which are target disks. At the downstream end, an ejection cassette 13 is provided to recover the slave disks 14 ejected after magnetic transfer. At the center of the processes, an index table 15 is installed rotatably. Four holders 16 which hold master disks 18 and 20 (see FIG. 2 and FIG. 3) are installed on the index table 15 at equal intervals (90-degree intervals) in the rotational direction of the index table 15. The index table 15 is rotatably driven by a drive motor (not shown) intermittently so as to stop at each 90-degree interval. Consequently, the holders 16 are fed sequentially and stop at index positions corresponding to process positions, making it possible to perform multiple operations concurrently. Processes are performed at the respective process positions. That is, a joining process and decompression process are performed at a joining/decompression position 23, where the joining process brings the slave disks 14 supplied to the holders 16 into pressing contact with the master disks 18 and 20 held in the holders 16 (each of which is composed of a lower holder 26 and upper holder 28) and the decompression process reduces pressure in the holders 16. Also, a transfer process is performed at a transfer position 25 to perform magnetic transfer by the application of a magnetic field. Furthermore, a vacuum relief process and separation process are performed at a vacuum relief/separation position 27, where the vacuum relief process opens the holders 16 to the atmosphere and the separation process separates the slave disks 14 from the master disks 18 and 20. At a wait position 29, the holders 16 waits for next slave disks 14.

A disk supply line 17 is installed between the supply cassette 11 and index table 15. The disk supply line 17 consists, for example, of a chuck and a XYZ robot and takes slave disks 14 out of the supply cassette 11 one by one using the chuck. Then, the XYZ robot transports the slave disk 14 held in the chuck and delivers it to a holder 16 on the index table 15. A slave supply process is performed in this way. Incidentally, although a stand 19 is installed midway along the disk supply line 17 to relay slave disks 14 in the example shown in FIG. 1, the slave disks 14 may be delivered directly to the holders 16 without any stand 19.

On the other hand, a disk ejection line 21 is installed between the index table 15 and ejection cassette 13. The disk ejection line 21 consists, for example, of a chuck and a XYZ robot as is the case with the disk supply line 17 and transports the processed slave disks 14 one by one from the holders 16 and houses them in the ejection cassette 13. A slave ejection process is performed in this way.

FIG. 2 is a perspective view showing the essence of a simultaneous duplex transfer type magnetic transfer apparatus which magnetically transfers information contained in the master disks 18 and 20 held by the holders 16 on the index table 15 to slave disks 14 supplied to the holders 16 by the disk supply line 17. FIG. 3 is an exploded block diagram showing a joining unit 12 consisting of master disks 18 and 20, a slave disk 14, and a holder 16.

As shown in FIG. 2, for magnetic transfer, the master disks 18 and 20 held to the holder 16 by suction are brought into pressing contact with the slave disk 14. While the joining unit 12 is rotated, transfer magnetic fields are applied by magnetic field applicators (electromagnets) 22 placed above and below the joining unit 12. Consequently, information carried by the upper and lower master disks 18 and 20 are simultaneously transferred to both sides (recording surfaces) of the slave disk 14.

As shown in FIG. 3, the joining unit 12 for simultaneous duplex transfer consists of the lower master disk 18 which transfers information such as a servo signal to the lower recording surface of the slave disk 14, the upper master disk 20 which transfers information such as a servo signal to the upper recording surface of the slave disk 14, the lower holder 26 which holds the lower master disk 18 to a suction surface 24 by suction, and the upper holder 28 which holds the upper master disk 20 to a suction surface 24 by suction. The upper and lower holders 26 and 28, upper and lower master disks 18 and 20, and the slave disk 14 are pressed against each other with their centers aligned to bring the upper master disk 20 and lower master disk 18 into contact with respective sides of the slave disk 14.

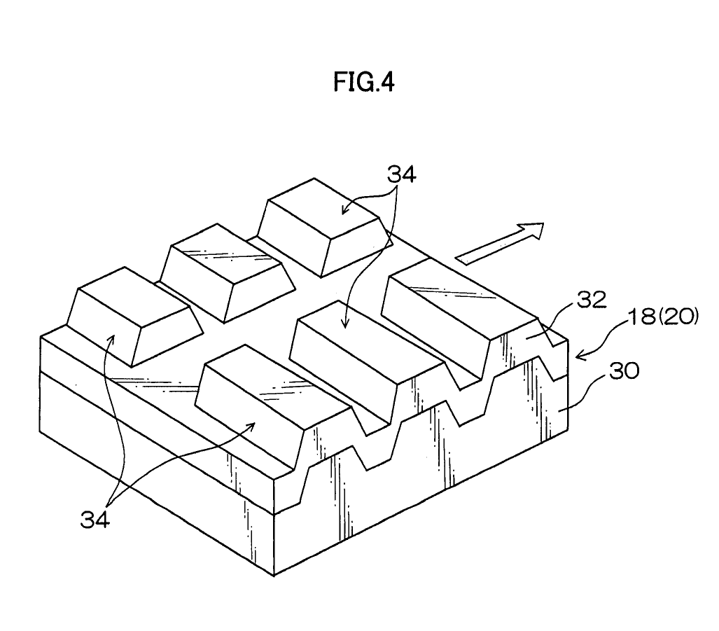

The lower master disk 18 and upper master disk 20 have an annular shape. Fine concavo-convex patterns 34 are formed on their surfaces, representing information to be transferred when they are brought into intimate contact with the recording surfaces of the slave disk 14. That is, as shown in FIG. 4, a magnetic layer 32 of the fine concavo-convex patterns 34 is formed on substrate 30 surfaces of the upper and lower master disks 18 and 20. In this case, preferably a protective film of diamond-like carbon (DLC) or a lubricant layer is provided on the magnetic layer 32. More preferably, a combination of a DLC film 5 to 30 nm thick and a lubricant layer is used as a protective film. A binding layer of Si or the like may be provided between the magnetic layer 32 and the protective film. The protective layer improves contact durability and makes it possible to perform magnetic transfer a large number of times.

As shown in FIG. 3, the lower holder 26 and upper holder 28 are formed into a disk shape corresponding to the size of the master disks 18 and 20. One or both of the lower holder 26 and upper holder 28 are movable in the axial direction. They are opened and closed by an opening/closing mechanism (such as a pressing mechanism or fastening mechanism: not shown) and pressed against each other at a predetermined pressure. They have collars 26a and 28a on their outer circumferences. When they are closed, their collars 26a and 28a abut each other, keeping the inner space airtight. A pin 26b is provided in the center of the lower holder 26 to position the slave disk 14 by being engaged with the center of a hub 14a of the slave disk 14. Also, the lower holder 26 and upper holder 28 are linked with a rotating mechanism (not shown) which rotatably drives the joining unit 12 integrally.

The suction surfaces 24 are formed on the lower holder 26 and upper holder 28, where the suction surfaces 24 have flatness on the order of 0.01 to 0.1 microns in terms of center line average surface roughness Ra. A large number of suction holes 24a are formed in the suction surfaces 24 to hold the back sides of the master disks 18 and 20 by suction. Preferably, the diameters of the suction holes 24a are between 0.3 mm and 1.5 mm (both inclusive). More preferably, they are between 0.6 mm and 1.2 mm (both inclusive).

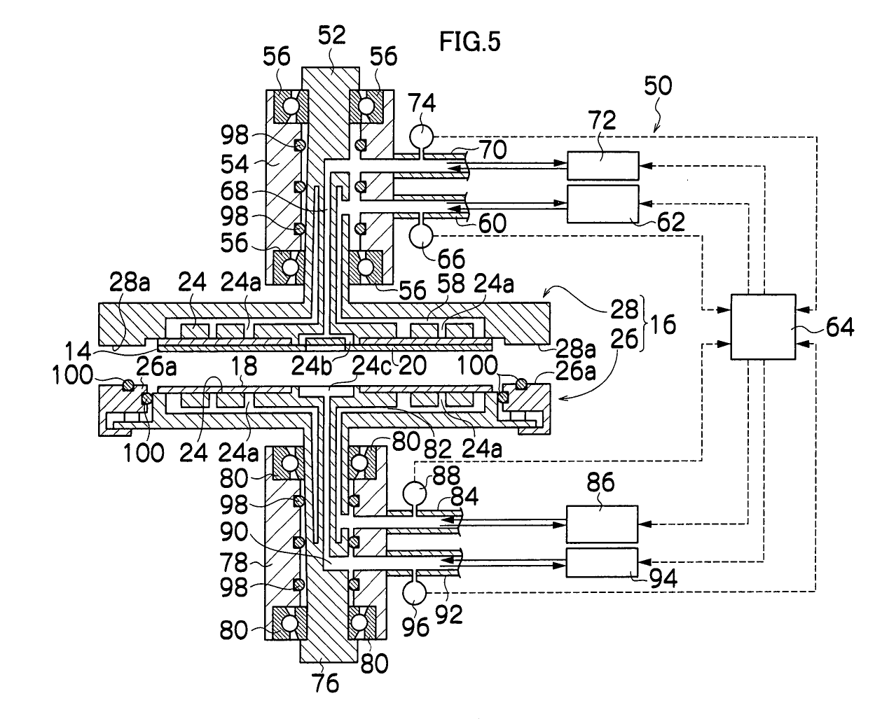

FIG. 5 is a sectional view illustrating a suction force control mechanism 50 which controls suction force of the suction holes 24a in the lower holder 26 and upper holder 28.

As shown in FIG. 5, an upper rotational axis 52 of the disk-shaped upper holder 28 is rotatably supported by an upper support member 54 via bearings 56. A large number of suction holes 24a are formed in the suction surface 24 of the upper holder 28. They are communicated with a vacuum pump 62 through an air suction channel 58 and air suction piping 60 which are formed in the upper holder 28, upper rotational axis 52, and upper support member 54. This makes it possible to hold the upper master disk 20 to the suction surface 24 by suction.

The vacuum pump 62 is connected to a controller 64 via a signal cable or wirelessly. The air suction piping 60 is equipped with a pressure sensor 66 which measures the suction force generated in the suction holes 24a. Measurements obtained by the pressure sensor 66 are inputted in the controller 64 in sequence. Based on the measurements from the pressure sensor 66, the controller 64 controls the rotational frequency (degree of vacuum) of the vacuum pump 62 in the slave supply process, joining process, decompression process, transfer process, vacuum relief process, separation process, and slave ejection process according to the suction force needed to hold the upper master disk 20 in the respective processes.

A ring-shaped suction hole 24b for use to hold the slave disk 14 by suction is formed in the center of the suction surface 24 of the upper holder 28. They are communicated with a suction/release device 72 through an air suction channel 68 and air suction piping 70 which are formed in the upper holder 28, upper rotational axis 52, and upper support member 54. This allows the ring-shaped suction hole 24b to suction-hold and release an inner circumferential surface of the slave disk 14 through a center hole formed in the center of the upper master disk 20. The suction/release device 72 is connected to the controller 64 via a signal cable or wirelessly. The air suction piping 70 is equipped with a pressure sensor 74 which measures the suction force generated in the suction hole 24b. Thus, by controlling the suction/release device 72, the controller 64 sucks and releases the slave disk 14 to/from the suction surface 24 and controls the suction force generated in the suction hole 24b.

The lower holder 26 has basically the same configuration as the upper holder 28, but it will be described in detail because it constitutes the essence of the present invention.

Specifically, a lower rotational axis 76 of the disk-shaped lower holder 26 is rotatably supported by a lower support member 78 via bearings 80. A large number of suction holes 24a are formed in the suction surface 24 of the lower holder 26. They are communicated with a vacuum pump 86 through an air suction channel 82 and air suction piping 84 which are formed in the lower holder 26, lower rotational axis 76, and lower support member 78. This makes it possible to hold the lower master disk 18 to the suction surface 24 by suction.

The vacuum pump 86 is connected to a controller 64 via a signal cable or wirelessly. The air suction piping 84 is equipped with a pressure sensor 88 which measures the suction force generated in the suction holes 24a. Measurements obtained by the pressure sensor 88 are inputted in the controller 64 in sequence. Based on the measurements from the pressure sensor 88, the controller 64 controls the rotational frequency (degree of vacuum) of the vacuum pump 86 in the slave supply process, joining process, decompression process, transfer process, vacuum relief process, separation process, and slave ejection process according to the suction force needed to hold the lower master disk 18 in the respective processes.

A large-diameter, circular suction hole 24c is formed in the center of the suction surface 24 of the lower holder 26 to reduce pressure inside the holder 16 after closing and sealing the holder 16 by abutting the collars 26a and 28a of the lower holder 26 and upper holder 28 against each other. The circular suction hole 24c is communicated with an air suction/vacuum relief device 94 through an air suction channel 90 and air suction piping 92 which are formed in the lower holder 26, lower rotational axis 76, and lower support member 78. This makes it possible to reduce pressure inside the holder 16 by sucking air out of the holder 16 or open the holder 16 to the atmosphere. The air suction/vacuum relief device 94 is connected to the controller 64 via a signal cable or wirelessly. The air suction piping 92 is equipped with a pressure sensor 96 which measures the decompression rate in the holder 16. This allows the controller 64 to reduce pressure in the holder 16 or open the holder 16 to the atmosphere and control the decompression rate in the holder 16 by controlling the air suction/vacuum relief device 94.

In this way, since the suction force of the large number of suction holes 24a formed in the suction surfaces 24 of the lower holder 26 and upper holder 28 is varied according to the suction force needed to hold the master disks 18 and 20 in individual processes, it is not necessary to maintain high suction force uniformly unlike the conventional practice. This minimizes deformation of the master disk in portions which correspond to the suction holes 24a, thereby preventing degradation of signal output and displacement of recording position during transfer. Moreover, since the suction force of the suction holes 24a is varied according to the suction force needed in individual processes, it is possible to securely hold the master disk by suction, preventing it from falling off the suction surface 24.

Incidentally, reference numeral 98 designates a first O-ring. The first O-ring 98 ensures airtightness when the lower holder 26 and upper holder 28 rotate during transfer. Reference numeral 100 designates a second O-ring. The second O-ring 100 ensures airtightness of the closed holder 16.

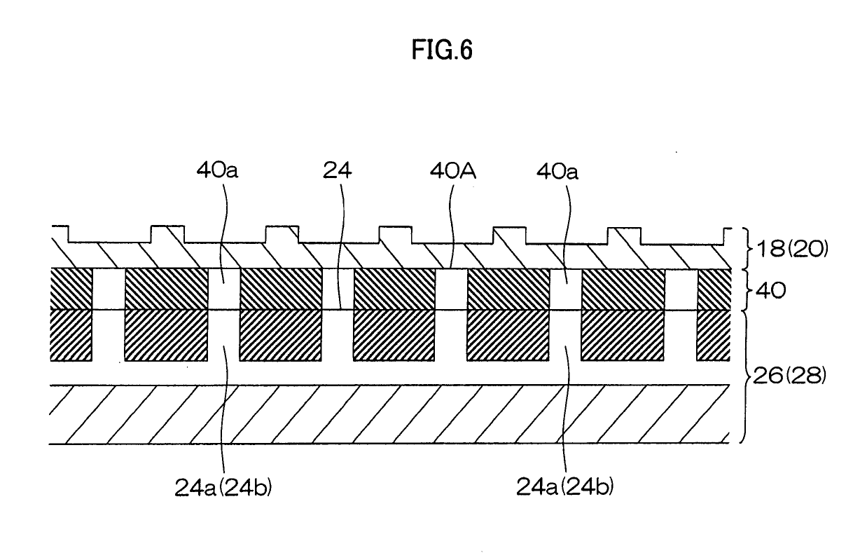

Instead of placing the slave disk 14 and master disks 18 and 20 in direct pressing contact with each other, cushioning 40 may be placed between them. As shown in FIG. 6, the cushioning 40 is installed on the suction surfaces 24 of the holders 26 and 28. In this way, by installing the cushioning 40 on the suction surfaces 24, it is possible to further reduce deformation when holding the master disks 18 and 20. In this case, it is not necessary that suction holes 40a formed in a cushion surface 40A will be the same as the suction holes 24a formed in the suction surfaces 24 as long as the suction holes 24a are formed in the cushion surface 40A in such a way as to at least provide a sufficient suction force. Although not shown in FIG. 6, a ring-shaped suction hole 40b is formed in the cushioning 40 of the upper holder 28 and a circular suction hole 40c is formed in the cushioning of the lower holder 26.

The cushioning 40 is made of an elastic material and formed into a disk shape. It is held to the suction surfaces 24 of the lower holder 26 and upper holder 28. The cushioning 40 must have a tendency to deform following the surface geometry of the slave disk 14 when pressure is applied for close contact, and return to its original surface state when the slave disk 14 is separated from the master disks 18 and 20. Specifically, available materials of the cushioning 40 include foam resins such as sponge rubber as well as ordinary rubbers such as silicon rubber, polyurethane rubber, fluorine rubber, butadiene rubber, Teflon (registered trademark) rubber, and Viton rubber. That surface of the cushioning 40 which contacts the slave disk 14 has a flat shape parallel to the master disks 18 and 20 or a shape convex toward the slave disk.

Next, description will be given of a magnetic transfer method for magnetically transferring concavo-convex patterns 34 from the master disks 18 and 20 to the slave disk 14 using the magnetic transfer apparatus 10 configured as described above.

Incidentally, it is assumed that the suction force needed to hold the master disks 18 and 20 to the suction holes 24a in each of the processes described above is at one of three levels: “low level,” “medium level,” “high level.” Preferably, the low level ranges from 0 to −60 kPa, the medium level ranges from −20 to −80 kPa, and the high level ranges from −60 to −101 kPa in terms of vacuum measured by the pressure sensors 66 and 88. However, these levels can vary depending on the material of the master disks 18 and 20 or whether cushioning 40 is installed on the suction surfaces 24, and thus are not limited to the ranges cited above. Here, a vacuum of 0 kPa at the “low level” is indicated in terms of atmospheric pressure and corresponds to a state in which the suction force of the suction holes 24a is zero. As described later, the “low level” does not include a vacuum of 0 kPa except in the transfer process.

In FIG. 1, four holders 16 which perform different processes simultaneously are provided, but his complicates description. Thus, it is assumed in the following description that a single holder 16 performs different processes in sequence.

When operation is started, the chuck on the disk supply line 17 grips and retrieves slave disks 14 from the supply cassette 11 one by one. The retrieved slave disk 14 is transported by the XYZ robot and inserted in a gap between the master disks 18 and 20 in the holder 16 whose lower holder 26 and upper holder 28 are closed (slave supply process). In the slave supply process, the master disks 18 and 20 in the holder 16 are simply held to the suction surfaces 24 by suction and no such external force is exerted that would cause the master disks 18 and 20 to fall off. Thus, there is no need to increase the suction force of the suction holes 24a, and preferably the controller 64 maintains the suction force of the suction holes 24a between the “low level” and “medium level” by reducing the rotational frequency of the vacuum pumps 62 and 86 for the upper holder 28 and lower holder 26. Consequently, even if the suction force of the suction holes 24a set to the “high level” causes the master disks to deform in the portions which correspond to the suction holes 24a in the suction surfaces 24 when the previous slave disk 14 is separated from the master disks 18 and 20 in the separation process, the deformation will not persist until the next transfer because the suction force of the suction holes 24a is kept at a low level until the next slave disk 14 is supplied to the holder 16 and undergoes transfer. This prevents degradation of signal output or displacement of recording position during transfer. However, if the master disks 18 and 20 are resistant to deformation depending on their material, the suction force of the suction holes 24a may be set to the “high level.” The same applies to the subsequent processes.

The slave disk 14 supplied to between the upper holder 28 and lower holder 26 is moved to a recognition position with a gap of approximately 0.5 mm, and is positioned such that its center will be aligned with the centers of the upper holder 28 and lower holder 26. Then, the master disks 18 and 20 are brought into pressing contact with the slave disk 14 (joining process). Then, the controller 64 reduces pressure in the sealed holder 16 by controlling the air suction/vacuum relief device 94 of the lower holder 26 (decompression process). In the joining process, since the master disks 18 and 20 are brought into pressing contact with the slave disk 14, if the suction force of the suction holes 24a is too low, the center of the master disks 18 and 20 and the center of the target disk will be misaligned with each other. However, the joining process does not require so high a suction force as the separation process. In the decompression process, as the space formed by sealing the holder 16 is decompressed, air entrapped between the master disks 18 and 20 and slave disk 14 held in pressing contact is discharged, bringing the master disks 18 and 20 and the slave disk 14 into tight contact with each other. Thus, in the joining process and decompression process, since there is no need to increase the suction force of the suction holes 24a, the controller 64 maintains the suction force of the suction holes 24a between the “low level” and “medium level” by reducing the rotational frequency of the vacuum pumps 62 and 86 for the upper holder 28 and lower holder 26. This makes it possible to reduce the duration during which high suction force is maintained as in the case of the separation process, and thereby reduce deformation of the master disks.

Next, the index table 15 is rotated 90 degrees to position the holder 16 at the transfer position 25 for the next process. The magnetic field applicators 22 are moved to both sides of the holder 16, and magnetic fields are applied from both sides by rotating the joining unit 12. Consequently, magnetic information patterns are transferred from the master disks 18 and 20 to both sides of the slave disk 14. During the transfer process, since the master disks 18 and 20 and slave disk 14 are held in pressing contact with each other integrally as the joining unit 12, as described above, there is no need to increase the suction force of the suction holes 24a. The controller 64 maintains the suction force of the suction holes 24a at the “low level” by minimizing the rotational frequency of the vacuum pumps 62 and 86 for the upper holder 28 and lower holder 26. In the transfer process, the “low level” can be 0 kPa. This is because the master disks 18 and 20, which are placed in pressing contact with the slave disk 14, will not fall off the suction surfaces 24 even at a vacuum of 0 kPa. This makes it possible to minimize the suction force of the suction holes 24a, and thus achieve maximum effect during transfer when it is most necessary to prevent deformation of the master disks 18 and 20.

Next, after the magnetic transfer, the magnetic field applicators 22 are retracted to their initial positions and the index table 15 is rotated 90 degrees to position the holder 16 at the vacuum relief/separation position 27 for the next process.

Next, the controller 64 opens the sealed holder 16 to the atmosphere by controlling the air suction/vacuum relief device 94 (vacuum relief process). Then it sets the lower holder 26 and upper holder 28 apart from each other. The chuck on the disk ejection line 21 gets between the lower holder 26 and upper holder 28 and grips the slave disk 14. Consequently, the slave disk 14 is separated from the master disks 18 and 20 (separation process). In the vacuum relief process, the sealed holder 16 in a decompressed state is opened to the atmosphere, breaking the vacuum and thereby giving rise to forces which tend to separate the master disks 18 and 20 from the suction surfaces. In the separation process, separation forces which tend to separate the slave disk 14 from the master disks 18 and 20 are given to the suction surfaces 24. Therefore, in the vacuum relief process and separation process, if the suction force of the suction holes 24a is too low, the master disks 18 and 20 will fall off the suction surfaces 24. Thus, in the vacuum relief process and separation process, the controller 64 maintains the suction force of the suction holes 24a at the “high level” by increasing the rotational frequency of the vacuum pumps 62 and 86 for the upper holder 28 and lower holder 26.

Next, the slave disks 14 after the transfer are transported to the ejection cassette 13 and housed in it one by one by being gripped in the chuck on the disk ejection line 21.

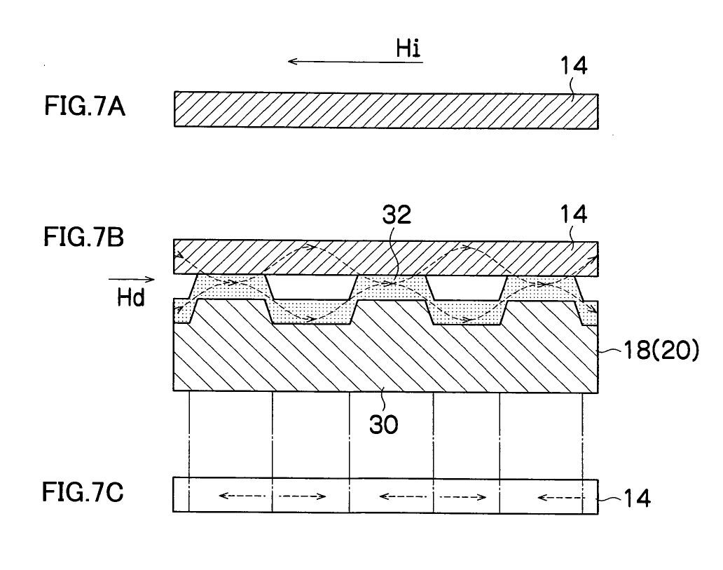

FIGS. 7A to 7C are explanatory diagrams illustrating basic processes of the magnetic transfer method which is based on in-plane recording.

First, as shown in FIG. 7A, the slave disk 14 is magnetized initially (DC demagnetization) by applying an initial magnetic field Hi in one direction along the tracks. Next, as shown in FIG. 7B, recording surfaces of the slave disk 14 are brought into close contact with information carrying surfaces of the master disks 18 and 20 on which concavo-convex patterns are formed, and magnetic transfer is performed by applying a transfer magnetic field Hd in the direction opposite to the initial magnetic field Hi along the tracks on the slave disk 14. The transfer magnetic field Hd is absorbed in a magnetic layer 32 in the convex part of the concavo-convex patterns and the magnetization of this part is not reversed, but the magnetic fields in the remaining part are reversed. Consequently, as shown in FIG. 7C, the concavo-convex patterns 34 of the master disks 18 and 20 are transferred to and recorded on the magnetic recording surfaces of the slave disk 14.

In the case of in-plane recording, the magnetic field applicators 22 which apply the initial magnetic fields and transfer magnetic fields are ring-shaped electromagnetic heads disposed one above the other, each consisting of a coil wound around a core which has a gap extending in a radial direction of the slave disk 14. The upper and lower electromagnetic heads apply the transfer magnetic fields in the same direction parallel to the direction of the tracks. The magnetic field applicators 22 may be disposed only on one side or permanent magnets may be disposed on both sides or on one side. Also, the magnetic field applicators 22 may be rotated.

In the case of vertical recording, electromagnets or permanent magnets of opposite polarity are disposed above and below the joining unit 12 containing the slave disk 14 and master disks 18 and 20, to generate and apply magnetic fields. In the case where magnetic fields are applied partially, the entire surfaces of the slave disk 14 are subjected to magnetic transfer by moving the joining unit 12 of the slave disk 14 and master disks 18 and 20 or by moving the magnetic fields. Also, instead of placing the slave disk 14 and master disks 18 and 20 in direct pressing contact with each other, cushioning 40 may be placed between them.

A method for creating the master disks 18 and 20 will be described next. The substrates 30 of the master disks 18 and 20 are made of nickel, silicon, quartz, glass, aluminum, alloy, ceramic, synthetic resin, or the like. The concavo-convex patterns are formed by stamper process, photofabrication process, or the like.

The stamper process involves applying photoresist to a flat surface of a glass plate (or quartz plate) by spin coating or the like, irradiating the glass plate with a laser beam (or electron beam) modulated according to a servo signal while the glass plate is rotated, exposing those areas which correspond to frames on the disk surface, and thereby forming predetermined patterns such as concavo-convex patterns extending radially from the center of rotation and corresponding to the servo signal on the entire surface of the photoresist. Then, the photoresist is developed, the exposed areas are etched away to obtain an original master on which the concavo-convex patterns are formed by photoresist. The surface of the original master is plated (electroformed) to obtain a Ni substrate with positive concavo-convex patterns and the Ni substrate is separated from the original master. The substrate is used as it is to provide a master disk or the concavo-convex patterns are coated with a magnetic layer or protective layer, as required, to provide the master disk 18 or 20.

Alternatively, a second original master may be created by plating the first original master, and then a substrate with negative concavo-convex patterns may be created by plating the second original master. Furthermore, a third original master may be created by plating the second original master or by pressing liquid resin onto the second original master and solidifying the resin, and then a substrate with positive concavo-convex patterns may be created by plating the third original master.

On the other hand, after the photoresist patterns are formed on the glass plate, it is alternatively possible to produce holes in the glass plate by etching, remove the photoresist from the glass plate thereby obtaining an original master, and then form a substrate in the above manner.

Available materials for metal substrates include Ni and Ni alloy. Available plating methods for the substrates include various metal deposition methods such as electroless plating, electroforming, sputtering, and ion plating. The depth (height of projections) of the concavo-convex patterns on the substrate is preferably between 80 nm and 800 nm, and more preferably between 100 nm and 600 nm.

The magnetic layer 32 (soft magnetic body) is formed of magnetic material by a vacuum deposition method such as vacuum evaporation, sputtering, or ion plating, or a plating method. Available magnetic materials include Co, Co alloy (CoNi, CoNiZr, CoNbTaZr, etc.), Fe, Fe alloy (FeCo, FeCoNi, FeNiMo, FeAlSi, FeAl, FeTaN, etc.), Ni, and Ni alloy (NiFe). Preferable materials are FeCo and FeCoNi. The thickness of the magnetic layer 32 is preferably between 50 nm and 500 nm, and more preferably between 100 nm and 400 nm.

A master disk may be created by providing a magnetic layer on a surface of a resin substrate created using the original master. Available materials for the resin substrate include acrylic resins such as polycarbonate and poly methyl methacrylate; vinyl chloride resins such as copolymers of polyvinyl chloride or vinyl chloride; epoxy resins; amorphous polyolefin; and amorphous polyester. Polycarbonate is preferable in terms of humidity resistance, dimensional stability, and costs. Any burrs should be removed from moldings by burnishing or polishing. Alternatively, the original master may be spin-coated or bar-coated using ultraviolet curing resin or electron radiation curing resin. The height of the projections in the patterns on the substrate is preferably between 50 nm and 1000 nm, and more preferably between 100 nm and 500 nm.

The master disks 18 and 20 are produced by coating the concavo-convex patterns on the surface of the resin substrate with a magnetic layer. The magnetic layer is formed of magnetic material by a vacuum deposition method such as vacuum evaporation, sputtering, or ion plating, or a plating method.

On the other hand, the photofabrication process involves, for example, applying photoresist on a flat surface of a planar substrate and forming concavo-convex patterns corresponding to information through exposure and developing using a photomask corresponding to a servo signal pattern. Next, in an etching process, the substrate is etched according to the concavo-convex patterns to produce pits of depth equivalent to the thickness of the magnetic layer. Then, magnetic material is deposited to the surface of the substrate, i.e., to a thickness equivalent to the depth of the produced pits, by a vacuum deposition method such as vacuum evaporation, sputtering, or ion plating, or a plating method. Then, the photoresist is removed by lift-off method and the surface is polished smooth by removing any burrs.

The vertical recording uses almost the same master disks 18 and 20 as the in-plane recording. In the vertical recording, the slave disk 14 initially magnetized in a vertical direction by a direct current is placed in close contact with the master disks 18 and 20 and magnetic transfer is performed by applying a transfer magnetic field in a direction approximately opposite to the direction of the initial DC magnetization. The transfer magnetic field is absorbed in a magnetic layer in the convex part of the concavo-convex patterns and the vertical magnetization of this part is reversed. Consequently, the magnetization patterns corresponding to the concavo-convex patterns are recorded on the slave disk 14.

Next, the slave disk 14 will be described. The slave disk 14 is a disk-shaped magnetic recording medium such as a high-density flexible disk or hard disk with a magnetic recording section (magnetic layer) formed on one or both sides. The magnetic recording section consists of a coat-type magnetic recording layer or thin metal film type magnetic recording layer. Available magnetic materials for the thin metal film type magnetic recording layer include Co, Co alloy (CoPtCr, CoCr, CoPtCrTa, CoPtCrNbTa, CoCrB, CoNi, etc.), Fe, and Fe alloy (FeCo, FePt, and FeCoNi). For a clear-cut transfer, preferably these materials have high magnetic flux density and magnetic anisotropy in the same direction as the direction of application of the magnetic field (in-plane direction in the case of in-plane recording or vertical direction in the case of vertical recording). To provide the required magnetic anisotropy, preferably a non-magnetic underlayer is provided under the magnetic material (on the side of a support member). It is necessary to adjust a crystal structure and lattice constant to the magnetic layer. For that, Cr, CrTi, CoCr, CrTa, CrMo, NiAl, or Ru should be used.

Although an example of simultaneous duplex transfer has been described in this embodiment, the present invention is applicable to magnetic transfer apparatus for simplex transfer as well.

### EXAMPLE

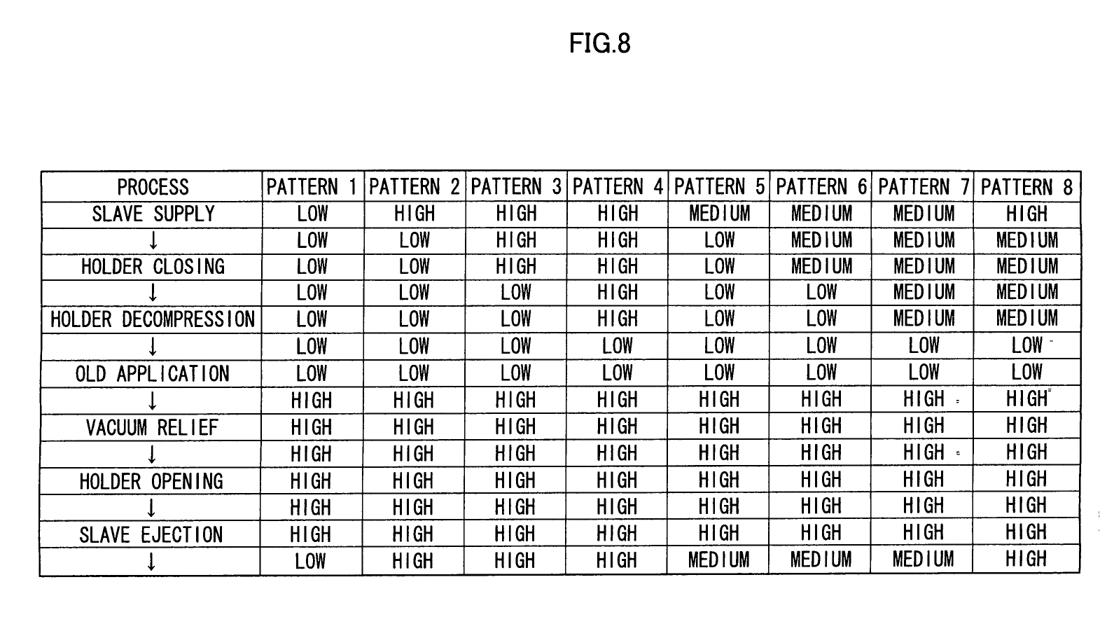

FIG. 8 is a table showing various patters of the magnetic transfer method according to the present invention for the magnetic transfer apparatus 10 according to the present invention.

In the table, the processes titled Slave Supply, Holder Closing, Holder Decompression, Field Application, Vacuum Relief, Holder Opening, and Slave Ejection correspond to the slave supply process, joining process, decompression process, transfer process, vacuum relief process, separation process, and slave ejection process, respectively.

In Pattern 1, the suction force of the suction holes 24a is maintained at the “low level” from slave supply to the end of field application, maintained at the “high level” from the end of field application to slave ejection, set to the “low level” after slave ejection, and maintained at the “low level” through to the next slave supply. Pattern 1 is suitable when the master disks 18 and 20 are prone to deformation.

In Pattern 2, the suction force of the suction holes 24a is set once to the “high level” to suck the master disks 18 and 20 to the suction surfaces 24 securely, maintained at the “low level” until the end of field application, set to the “high level” after the end of field application, and maintained at the “high level” through to the next slave supply.

In Pattern 3, the suction force of the suction holes 24a is maintained at the “high level” from slave supply to the end of holder closing, maintained at the “low level” after the end of holder closing until the end of field application, set to the “high level” after the end of field application, and maintained at the “high level” through to the next slave supply.

In Pattern 4, the suction force of the suction holes 24a is maintained at the “high level” from slave supply to the end of holder decompression, maintained at the “low level” after the end of holder decompression until the end of field application, set to the “high level” after the end of field application, and maintained at the “high level” through to the next slave supply. Pattern 4 is suitable when the master disks 18 and 20 are resistant to deformation.

In Pattern 5, the suction force of the suction holes 24a is set once to the “medium level” to suck the master disks 18 and 20 to the suction surfaces 24 securely, maintained at the “low level” until the end of field application, maintained at the “high level” after the end of field application until the end of slave ejection, and set to the “medium level” after the end of slave ejection, and maintained at the “medium level” through to the next slave supply.

In Pattern 6, the suction force of the suction holes 24a is maintained at the “medium level” from slave supply to the end of holder closing, maintained at the “low level” after the end of holder closing until the end of field application, maintained at the “high level” after the end of field application until the end of slave ejection, set to the “medium level” after the end of slave ejection, and maintained at the “medium level” through to the next slave supply.

In Pattern 7, the suction force of the suction holes 24a is maintained at the “medium level” from slave supply to the end of holder decompression, maintained at the “low level” after the end of holder decompression until the end of field application, maintained at the “high level” after the end of field application until the end of slave ejection, set to the “medium level” after the end of slave ejection, and maintained at the “medium level” through to the next slave supply.

In Pattern 8, the suction force of the suction holes 24a is set once to the “high level” to suck the master disks 18 and 20 to the suction surfaces 24 securely, maintained at the “medium level” until the end of holder decompression, maintained at the “low level” after the end of holder decompression until the end of field application, set to the “high level” after the end of field application, and maintained at the “high level” through slave ejection to the next slave supply.

As can be seen from the above description, preferably, the suction force is maintained at the “low level” during transfer in the transfer process (from the start to the end of transfer) in any of the patterns, maintained at the “high level” after the end of the transfer process until the end of slave ejection in any of the patterns, and set between the “low level” and “high level” in the other processes, as required, according to the material of the master disks 18 and 20 and other conditions.

Any of the patterns allowed the master disks 18 and 20 to be held securely to the suction surfaces 24 of the holder 16 in every process without degradation of signal output or displacement of recording position during transfer. For example, if each suction surface 24 has 84 suction holes 24a 1.5 mm in diameter and the degree of vacuum during the separation process is −100 kPa, the suction force of the suction holes 24a is 1500 gf. On the other hand, if the degree of vacuum during the transfer process is −20 kPa, the suction force of the suction holes 24a is 300 gf. Since the separation force acting on the suction holes 24a when the slave disk 14 is separated from the master disks 18 and 20 is 500 gf, if the degree of vacuum during the separation process is −100 kPa, the master disks 18 and 20 will not fall off the suction surfaces 24. In this way, if the suction force of the large number of suction holes 24a formed in the suction surfaces is varied according to the suction force needed to hold the master disks 18 and 20 in individual processes, it is possible to minimize deformation of the master disks in portions which correspond to the suction holes 24a.

What is claimed is:

1. A magnetic transfer method, comprising:
a joining step of overlaying a master disk held by suction to a suction surface of a holder on a target disk and bringing the master disk and the target disk into pressing contact with each other;
a transfer step of magnetically transferring concavo-convex patterns which represent information on the master disk to the target disk by applying a magnetic field with the master disk and the target disk held in pressing contact; and
a separation step of separating the target disk from the master disk after transfer,
wherein suction force of suction holes or suction grooves formed in the suction surface is varied according to suction force needed to hold the master disk in the individual steps.

2. The magnetic transfers method according to claim 1, wherein the suction force of the suction holes or suction grooves is set lower during a transfer operation in the transfer step than in the separation step.

3. The magnetic transfer method according to claim 1, wherein the suction force of the suction holes or suction grooves in the joining step is set to be intermediate between the suction force in the transfer step and the suction force in the separation step.

4. The magnetic transfer method according to claim 2, wherein the suction force of the suction holes or suction grooves in the joining step is set to be intermediate between the suction force in the transfer step and the suction force in the separation step.

5. The magnetic transfer method according to claim 1, wherein the suction force of the suction holes or suction grooves during a transfer operation in the transfer step ranges from 0 to −60 kPa in terms of vacuum created by a vacuum system which generates the suction force of the suction holes or suction grooves.

6. The magnetic transfer method according to claim 4, wherein the suction force of the suction holes or suction grooves during a transfer operation in the transfer step ranges from 0 to −60 kPa in terms of vacuum created by a,vacuum system which generates the suction force of the suction holes or suction grooves.

7. The magnetic transfer method according to claim 1, further comprising:
a supply step of supplying the target disk to the holder, the supply step being provided upstream of the joining step,
wherein the suction force of the suction holes or suction grooves is kept as low as the suction force in the transfer step or the joining step until the target disk is supplied to the holder in the supply step.

8. The magnetic transfer method according to claim 6, further comprising:
a supply step of supplying the target disk to the holder, the supply step being provided upstream of the joining step,
wherein the suction force of the suction holes or suction grooves is kept as low as the suction force in the transfer step or the joining step until the target disk is supplied to the holder in the supply step.

9. The magnetic transfer method according to claim 1, further comprising:
a decompression step of decompressing a space formed by sealing the holder, the decompression step being provided between the joining step and the transfer step,
wherein the suction force of the suction holes or suction grooves is lowered to a level of the suction force in the transfer step before a shift from the decompression step to the transfer step.

10. The magnetic transfer method according to claim 8, further comprising:
a decompression step of decompressing a space formed by sealing the holder, the decompression step being provided between the joining step and the transfer step,
wherein the suction force of the suction holes or suction grooves is lowered to a level of the suction force in the transfer step before a shift from the decompression step to the transfer step.

11. A magnetic transfer apparatus equipped with a holder which holds the back side of a master disk by suction to a suction surface which has suction holes or suction grooves, where concavo-convex patterns representing information are formed on the front side of the master disk, the magnetic transfer apparatus comprising:
a suction force control mechanism which controls suction force of the suction holes or suction grooves.

12. The magnetic transfer apparatus according to claim 11, further comprising:
a joining device which overlays a master disk held by suction to a suction surface of a holder on a target disk and brings the master disk and the target disk into pressing contact with each other;
a transfer device which magnetically transfers the concavo-convex patterns on the master disk to the target disk by applying a magnetic field with the master disk and the target disk held in pressing contact; and
a separation device which separates the target disk from the master disk after transfer,
wherein the suction force control mechanism controls the suction force of the suction holes or suction grooves according to suction force needed by the individual devices to hold the master disk.

13. The magnetic transfer apparatus according to claim 11, further comprising:
a supply device which supplies the target disk to the holder, the supply device being provided upstream of the joining device; and
a decompression device which decompresses a space formed by sealing the holder, the decompression device being provided between the joining device and the transfer device,
wherein the suction force control mechanism controls the suction force of the suction holes or suction grooves according to suction force needed by the supply device and the decompression device to hold the master disk.

14. The magnetic transfer apparatus according to claim 12, further comprising:
a supply device which supplies the, target disk to the holder, the supply device being provided upstream of the joining device; and
a decompression device which decompresses a space formed by sealing the holder, the decompression device being provided between the joining device and the transfer device,
wherein the suction force control mechanism controls the suction force of the suction holes or suction grooves according to suction force needed by the supply device and the decompression device to hold the master disk.

15. A manufacturing method of magnetic recording media, employing the magnetic transfer method according to claim 1.

16. A manufacturing method of magnetic recording media, employing the magnetic transfer method according to claim 10.

17. A magnetic recording medium manufactured by the manufacturing method according to claim 15.

18. A magnetic recording medium manufactured by the manufacturing method according to claim 16.
